(19) United States
(12) Patent Application Publication
(10) Pub. No.: US 2016/0135387 A1
(43) Pub. Date: May 19, 2016

(54) TREE PROTECTION DEVICE AND METHOD

(71) Applicant: Jonathan STEWART, Charles Town, WV (US)

(72) Inventor: Jonathan STEWART, Charles Town, WV (US)

(21) Appl. No.: 14/582,504

(22) Filed: Dec. 24, 2014

Related U.S. Application Data
(60) Provisional application No. 62/081,122, filed on Nov. 18, 2014.

(51) Int. Cl. A01G 13/00

(52) U.S. Cl. CPC A01G 13/0237

(57) ABSTRACT

An apparatus and method for protecting trees from undesired contact or access. One exemplary embodiment describes a tree trunk protection device. The tree trunk protection device can have a flexible cord having a first end and a second end; a substantially inflexible cord having a first end and a second end; and a plurality of legs each having a top end and a bottom end. The plurality of legs may be coupled to a flexible cord having at a first end and forming a circle having a first diameter. Additionally, the plurality of legs can be coupled at a second end to a substantially inflexible cord forming a circle having a second diameter that is larger than the circle with the first diameter at the top of the plurality of legs, and the plurality of legs can have a plurality of spacers disposed between each of the plurality of legs.

### PRIORITY CLAIM

This application claims priority to U.S. Provisional Patent Application Ser. No. 62/081,122, entitled “Tree Protection Device and Method”, and filed Nov. 18, 2014, the contents of which are hereby incorporated by reference in their entirety.

### BACKGROUND

Trees are often found in the yards of homes, in parks, and in urban environments because of the various benefits they provide to the land and surrounding areas. Trees can improve ambient and environmental conditions, allow for enhanced scenery, and provide privacy, depending on their location.

However, often due to the location of trees, they are often subjected to various forms of abuse. Domesticated animals, such as dogs, frequently urinate on the trunks of trees. Landscaping devices, such as mowers and trimmers, often contact tree trunks. These actions, along with many others, can damage trees, cause premature death of trees, cause diminished aesthetics of trees, and harm areas surrounding trees. Various manners of protecting tree trunks currently utilized are expensive, cumbersome, unaesthetic, difficult to install or position, and ineffective for specifically protecting tree trunks, however.

### SUMMARY

In an exemplary embodiment, an apparatus and method for protecting a tree trunk may be described. The apparatus and method can include one or more legs which are fastened or coupled together in an adjustable fashion. The apparatus or method can further include the capability of coupling a first leg to a second leg in such a fashion that the device encircles the trunk of a tree to provide a barrier between the trunk of a tree and a surrounding area, for example to prevent access to or contact with the tree by any object or animal.

An apparatus and method for protecting trees from undesired contact or access. One exemplary embodiment describes a tree trunk protection device. The tree trunk protection device can have a flexible cord having a first end and a second end; a substantially inflexible cord having a first end and a second end; and a plurality of legs each having a top end and a bottom end. The plurality of legs may be coupled to a flexible cord having at a first end and forming a circle having a first diameter. Additionally, the plurality of legs can be coupled at a second end to a substantially inflexible cord forming a circle having a second diameter that is larger than the circle with the first diameter at the top of the plurality of legs, and the plurality of legs can have a plurality of spacers disposed between each of the plurality of legs.

In another exemplary embodiment, a method of protecting a tree trunk may be shown and described. The method can include disposing a flexible cord coupled to a top portion of a plurality of legs to a tree trunk; anchoring a bottom portion of a plurality of legs with a cord coupled thereto to ground in a conical fashion; securing the nylon cord to the tree trunk to prevent movement; and creating a protective barrier around a tree trunk with the plurality of legs.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

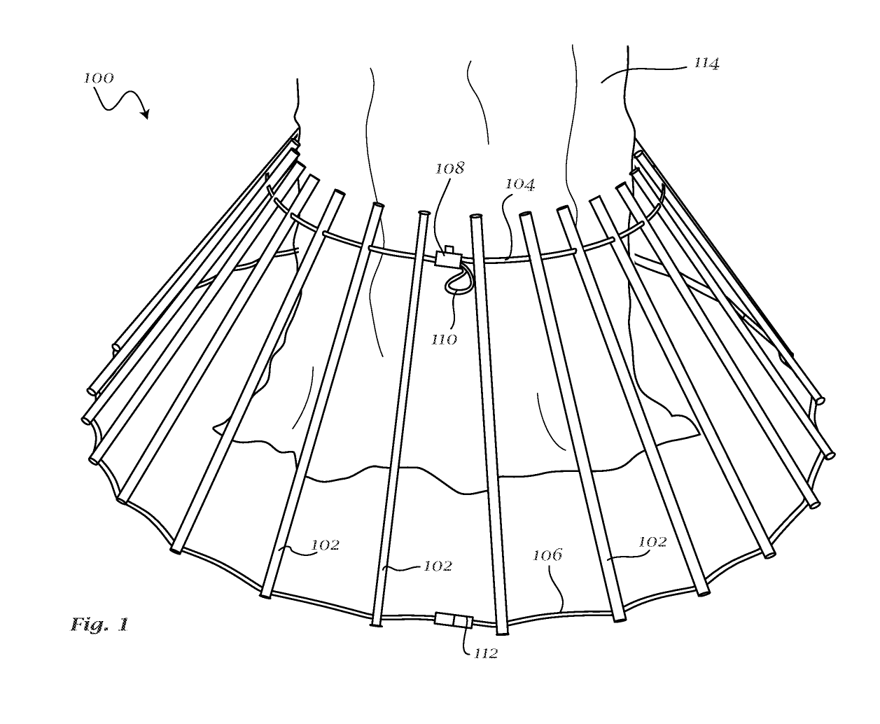

Exemplary FIG. 1 shows an exemplary view of a tree trunk protection device secured around a tree trunk.

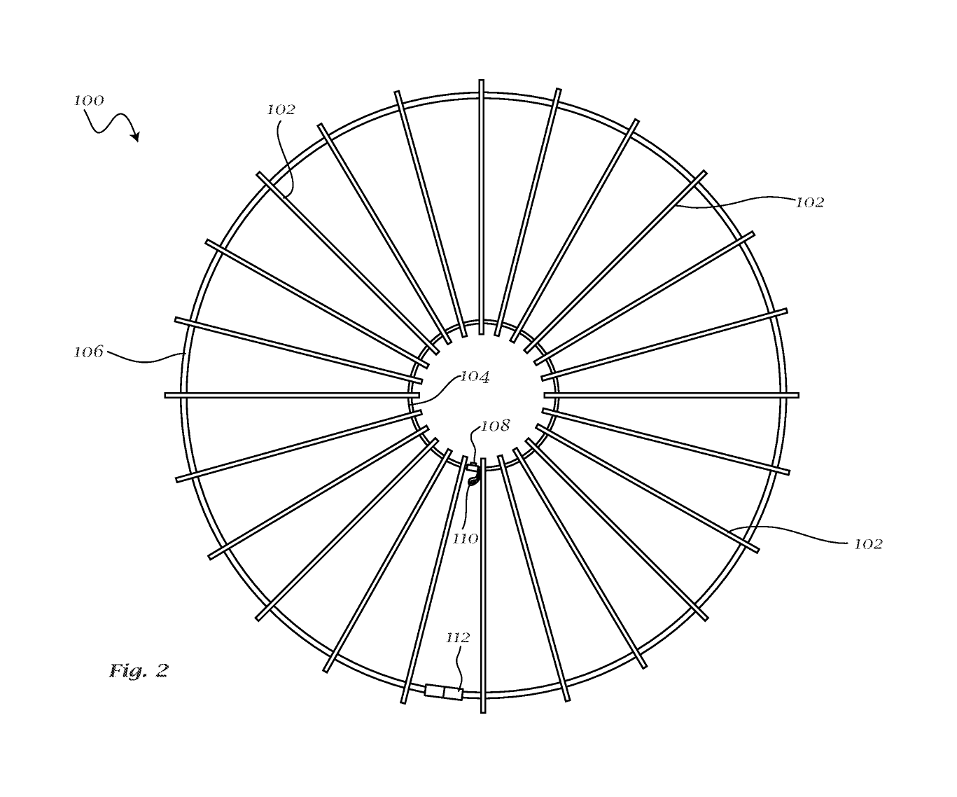

Exemplary FIG. 2 shows an exemplary top-down view of a tree trunk protection device in a collapsed position.

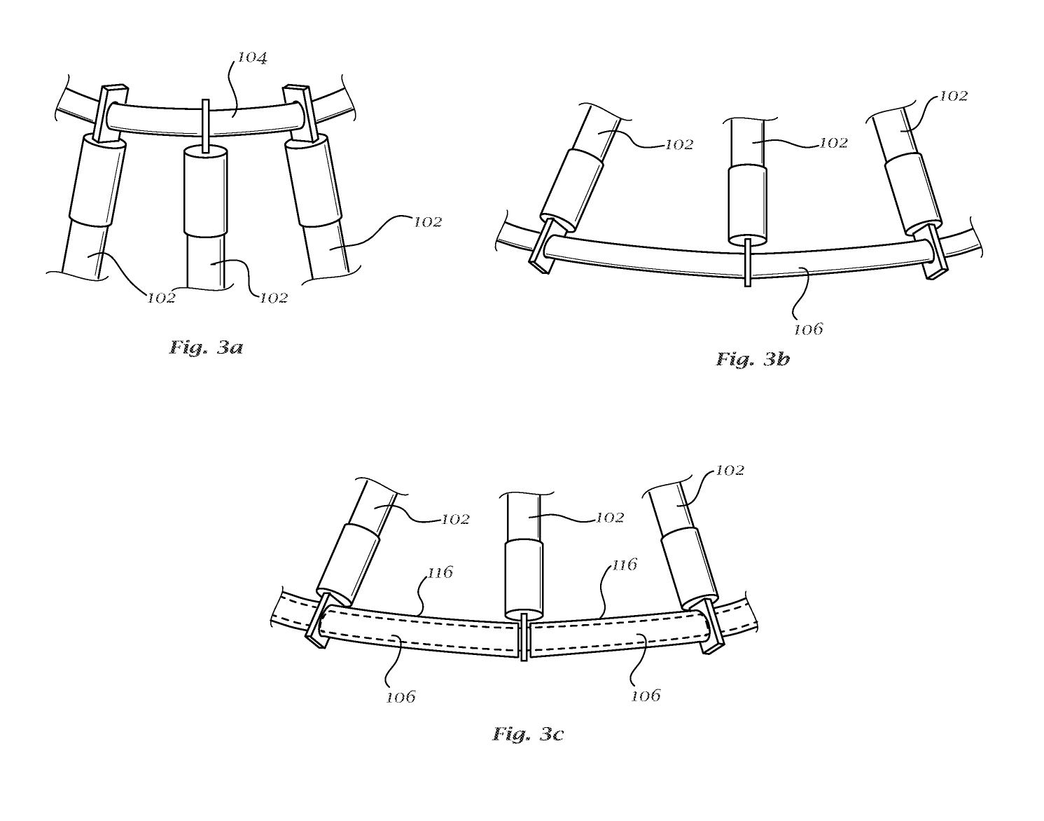

Exemplary FIG. 3a shows an exemplary view of a top portion of a tree trunk protection device.

Exemplary FIG. 3b shows an exemplary view of a bottom portion of a tree trunk protection device.

Exemplary FIG. 3c shows an exemplary view of a tree trunk protection device with spacers provided between bottom portions of the legs of the device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Generally referring to FIGS. 1-4, exemplary embodiments of a tree trunk protection device may be shown and described. The tree trunk protection device may be formed using a variety of components and may be secured around a tree trunk, or any other cylindrical object, so as to provide a protective barrier between the tree trunk, and a surrounding area of the tree trunk, and any undesired contact with the tree trunk.

Referring now to exemplary FIG. 1, in one embodiment, the tree trunk protection device 100 may include any number of legs 102. For example, any number of legs 102, such as about 20 to 40 or more legs, as desired, may be utilized in the device 100. Legs 102 may be any desired length and may have any shape, width, diameter, or other dimension, as desired. Additionally, legs 102 may be formed out of any material, for example wood, plastic, composites, metal, or any combination thereof. For example, legs 102 may be formed of a composite material and may be substantially flexible and resilient. Legs 102 may further be substantially scratch resistant and may be formed to be any desired color. Additionally, although legs 102 in exemplary FIG. 1 are shown as having a smooth surface, it may be appreciated that legs 102 can have any texture or pattern formed thereon. In some further exemplary embodiments, legs 102 could be illuminated, provide illumination, or glow, as desired, to provide more visibility to the device 100.

Still referring to exemplary FIG. 1, as well as exemplary FIG. 2, legs 102 may further be joined or coupled in any desired fashion. For example, a flexible cord 104, which may be a nylon cord, a bungee cord, or any cord or wire that is substantially flexible (or inflexible, in certain exemplary embodiments) or capable of stretching, may be passed through holes at a top portion of legs 102. Additionally, flexible cord 104, as well as any other cord or component described herein, may be substantially weatherproof, as desired. Alternatively, and as shown in exemplary FIG. 3a, flexible cord 104 may be passed through a series of dowels 302 that can be used to couple legs 102. Dowels 302 may be secured to top portions of legs 102 in any desired fashion, for example through the use of an adhesive or through the use of mechanical fasteners, such as screw threading. Dowels 302 may be formed out of any desired material. Dowels 302 may further act to fluidly move along flexible cord 104 so as to allow for any desired positioning of legs 102 of device 100, for example positioning flexible cord 104 around a tree trunk 114 with legs 102 spaced at desired intervals. Dowels 302 may further have squared or angled heads, or any type of claw disposed thereon, which may cause contact and friction with a tree trunk, for example better securing device 100 in a desired position on a tree trunk.

Additionally, a cord 106 or other connecting piece may be passed through holes at a bottom portion of legs 102, or, as shown in exemplary FIG. 3b, dowels 304 at a bottom portion of legs 102. Dowels 304 may share any characteristics as dowels 302, described above. Additionally, dowels 304 may have squared or angled heads, or may have an anchor disposed thereon that can allow for further securing of device 100 to the ground. Cord 106 may be substantially inflexible. However, in certain exemplary embodiments, any flexible or inflexible elements may be used as substitutes for flexible cord 104 and cord 106. Further, legs 102 may be spaced apart at top portions and bottom portions in any desired fashion, for example by using spacers 116 or inserts between the legs on flexible cord 104 and/or cord 106. This can be shown further with respect to FIG. 3c, as described in more detail below. However, in exemplary FIG. 2, when tree trunk protection device 100 is not in use, it may lay substantially flat and may be folded of compacted in any desired fashion, for example to store device 100 when not in use. Flexible cord 104 may form a first circle having a first diameter proximate a top portion of device 100. As stated previously, flexible cord 104 may be substantially flexible, allowing for flexible cord 104 to be stretched and secured around the trunk of a tree (or around another cylindrical object, as desired). Cord 106 may form a second circle having a second diameter proximate a bottom portion of device 100. It may be appreciated that the second circle formed by cord 106 may have a diameter greater than that of the first circle formed by flexible cord 104. This may allow for the device 100 to be flared out from the top portion secured to tree trunk 114 and provide a protective barrier positioned between the tree trunk 114 and an area on the ground at the bottom of the device 100.

Still referring to exemplary FIGS. 1 and 2, at one end of flexible cord 104 may be a securing device, such as spring stop 108. Spring stop 108 may be such that it is secured on flexible cord 104, for example by having flexible cord 104 pass through a portion of spring stop 108. Additionally, at another end of flexible cord 104 may be a loop 110. Loop 110 may be such that it can be secured to spring stop 108 in order to substantially form a circle where two ends of flexible cord 104 are secured with spring stop 108. As shown in exemplary FIGS. 1 and 2, spring stop 108 is shown securing two ends of flexible cord 104 together. It may be appreciated that the diameter of the circle formed by the top portion of the tree trunk protection device 100 may be adjusted by tightening or loosening flexible cord 104 in spring stop 108. This may allow for tree trunk protection device 100 to be secured around the trunk 114 of a tree having any diameter, as desired.

At the bottom portion of legs 102 on cord 106, clasp 112 may be disposed at two end portions of cord 106. Clasp 112 may have male and female ends which couple to each other in such a secure fashion so as to lock the bottom portion of legs 102 substantially in a circle with a larger diameter than that at the top of legs 102. Clasp 112 may be any securing device, however, that may act to couple a first end of cord 106 to a second end of cord 106 securely. It may further be appreciated that any known or desired securing elements may be used at the top portion of legs 102 and at the bottom portion of legs 102, as desired.

In some further exemplary embodiments, it may be appreciated that spring stop 108 and clasp 112 may be any other type of securing or locking devices. For example, spring stop 108 or clasp 112 could be securing devices that lock and use a key or combination to open. Such exemplary embodiments may be beneficial to prevent undesired movement of device 100 or theft of device 100.

Referring back to exemplary FIG. 1, device 100 may be secured about the trunk 114 of a tree. Top portion of legs 102 of device 100 may be secured at any desired portion of tree trunk 114. For example, top portion of legs 102 may be secured at a height that substantially allows the bottom portion of legs 102 of device 100 to contact the ground or a surface in a flared-out or conical fashion where a base of device 100 is wider than a top portion of device 100 secured to tree trunk 114. Thus, device 100 may be secured as shown in exemplary FIG. 1. Additionally, because of the flexible cord 104, top portion of legs 102 may be secured snugly to tree trunk 114 so as to prevent any undesired movement of device 100. Further, dowels 302, as shown in exemplary FIG. 3a, may provide further grip or adhesion to tree trunk 114 insofar as they may provide a secure friction fit against textured bark of tree trunk 114. As described above, in some exemplary embodiments, dowels 302 may be formed out of any desired materials, for example plastic, metal, composites, and the like, or any combination thereof. Additionally, a top portion of dowels 302 may be structured such that dowels 302 further act to anchor device 100 against tree trunk 114 or provide further friction fitting against tree trunk 114. Additionally, dowels 302, or any other cap or capping device may be used at a top portion of legs 102 to prevent moisture, or any undesired materials, from entering legs 102.

In still a further exemplary embodiment, bottom portions of legs 102 may be spread out on the ground in any desired fashion, for example the circular fashion shown in exemplary FIG. 1. Additionally, it may be appreciated that bottom portions of legs 102 may have any desired anchoring mechanism so as to allow for legs 102 to be secured or anchored into the ground in any desired fashion to prevent any undesired movement. For example, dowels 304 as shown in exemplary FIG. 3b may be such that they securely anchor device 100 to the ground or any other surface on which they rest. Additionally, dowels 304 may be formed in any fashion, as described above with respect to dowels 302, and may have any other structure incorporated therein to provide further anchoring or securing of device 100 in a desired place or location.

Further, as shown in exemplary FIG. 3c, spacers 116 may be disposed between legs 102. Spacers 116 may be formed out of any material, as desired, for example plastic, composites, or rubber. Spacers 116 may be utilized to provide a predetermined or desired spacing between bottom portions of each of legs 102. This can allow for a uniform distribution of legs 102 of tree trunk protection device 100 around an area outside of the tree. This can aid in the setup and removal of device 100, along with providing structural rigidity and firmer protection of the device 100 around the tree.

As shown and described herein, a tree trunk protection device 100 may be formed and utilized to provide protection of a tree trunk, such as trunk 114, and an area surrounding a tree trunk. The device 100 may be such that it is substantially secured to a tree trunk 114 and provide a barrier to prevent undesired or unauthorized access or contact to an area surrounding a tree and a tree trunk 114. For example, the device 100 may be quickly and easily secured to a tree trunk 114 and may prevent any animal, such as a dog, from urinating on the tree trunk, thus hurting or negatively impacting the tree or the health of the tree. The device 100 can further act to protect an area substantially around a tree from undesired contact, for example liquid or chemical contact that could negatively impact the health or appearance of the tree. The device 100 can be quickly and efficiently erected and secured to a tree, as desired. Additionally, the device 100 can be quickly and easily removed from a tree and stored in a compact, flat, and/or folded fashion, as desired. Further, the device 100 can be adjusted in any desired fashion, for example by adding more legs 102 to provide greater coverage, by lengthening or shortening legs 102 to provide coverage to a greater or smaller area, by lengthening or shortening flexible cord 104 or cord 106 to provide the ability to fit the device on any sized tree trunk, and the like. Additionally, legs 102 may be formed in any shape and having any width or diameter, so as to provide varying levels of protection to the tree trunk 114 and the surrounding area. It may be appreciated, however, that the exemplary embodiment in FIG. 1 would prevent any undesired access or contact with the tree trunk 114 and the surrounding area, however it would still allow for desired contact, such as rainwater contacting the tree trunk 114 and surrounding areas to provide nourishment to the tree.

In further exemplary embodiments, as device 100 is secured to tree trunk 114 using flexible cord 104 and spring stop 108, the device 100 may be pivoted around the secure coupling provided by the device 100 to the tree trunk. For example, the device 100 could be rotated upwards and held in position so that the circle formed by flexible cord 104 remains in the same position, but the circle formed by cord 106 is above the circle formed by flexible cord 104. The device may remain securely in this position for any amount of time, as desired. For example, if it is desired to landscape in the area surrounding the tree trunk 114 which is within the diameter of the circle formed by cord 106 when the device 100 is positioned on the ground, the device 100 may be quickly and easily rotated upwards to provide access to that area.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A tree trunk protection device, comprising:
a flexible cord having a first end and a second end;
a substantially inflexible cord having a first end and a second end; and
a plurality of legs each having a top end and a bottom end;
the plurality of legs coupled to a flexible cord having at a first end and forming a circle having a first diameter;
the plurality of legs coupled at a second end to a substantially inflexible cord forming a circle having a second diameter that is larger than the circle with the first diameter at the top of the plurality of legs, and the plurality of legs having a plurality of spacers disposed between each of the plurality of legs at the bottom end and around the substantially inflexible cord to provide separation of each of the bottom ends of the plurality of legs by a predetermined distance from one another.

2. The tree trunk protection device of claim 1, further comprising a plurality of dowels disposed at the top end of the plurality of legs to couple the plurality of legs to the flexible cord.

3. The tree trunk protection device of claim 2, wherein the plurality of dowels disposed at the top end of the plurality of legs securely anchors the first circle to a tree trunk.

4. The tree trunk protection device of claim 1, further comprising a plurality of dowels disposed at the bottom end of the plurality of legs to couple the plurality of legs to the substantially inflexible cord.

5. The tree trunk protection device of claim 4, wherein the plurality of dowels disposed at the bottom end of the plurality of legs anchors the second circle to ground.

6. The tree trunk protection device of claim 1, wherein the flexible cord is a nylon cord.

7. The tree trunk protection device of claim 6, wherein the nylon cord secures the first circle around the trunk of a tree.

8. The tree trunk protection device of claim 1, wherein the legs are formed of a composite material.

9. The tree trunk protection device of claim 1, further comprising a securing device disposed on first and second ends of the flexible cord.

10. The tree trunk protection device of claim 9, wherein the securing device is a spring stop.

11. The tree trunk protection device of claim 8, wherein the securing device secures the flexible cord around a tree trunk.

12. The tree trunk protection device of claim 1, further comprising a securing device disposed on first and second ends of the substantially inflexible cord.

13. The tree trunk protection device of claim 12, wherein the securing device is a male-female clamp.

14. The tree trunk protection device of claim 1, wherein the plurality of legs are flexible and resilient.

15. A method of protecting a tree trunk, comprising:
disposing a flexible cord coupled to a top portion of a plurality of legs to a tree trunk;
anchoring a bottom portion of a plurality of legs with a cord coupled thereto to ground in a conical fashion;
securing the nylon cord to the tree trunk to prevent movement; and
creating a protective barrier around a tree trunk with the plurality of legs.

16. The method of claim 15, further comprising coupling the flexible cord to the top portion of the plurality of legs with a plurality of dowels.

17. The method of claim 15, further comprising coupling the cord to the bottom portion of the plurality of legs with a plurality of dowels.

18. The method of claim 15, further comprising separating the bottom portion of the plurality of legs by disposing spacers mounted around the cord between the plurality of legs.
